(19) United States
(12) Patent Application Publication
(10) Pub. No.: US 2010/0260205 A1
(43) Pub. Date: Oct. 14, 2010

(54) METHOD AND SYSTEM PROVIDING BACKWARD COMPATIBLE ENHANCEMENTS IN DVB-T SYSTEMS

(76) Inventor: Pierre-Jean BOUVET, Brest (FR)

Correspondence Address: DLA PIPER LLP (US), 2000 UNIVERSITY AVENUE, EAST PALO ALTO, CA, 94303, US

(21) Appl. No.: 12/423,199

(22) Filed: Apr. 14, 2009

(51) Int. Cl. H04J 3/24

(52) U.S. Cl. 370/474

(57) ABSTRACT

A method and system for providing enhanced encoding and correction capability while retaining backward compatibility with existing DVB-T transport systems is disclosed. The method comprises the steps of encoding a plurality of transport stream bytes into a transport stream matrix, wherein each column of said matrix represents a predetermined number of encoded transport stream bytes and a known number of parity bytes, and encoding said encoded bytes within said columns within corresponding ones of rows of said matrix, wherein a known number of parity bytes are associated with said encoded bytes within said row.

### BACKGROUND OF THE INVENTION

Digital Video Broadcasting-Terrestrial (DVB-T) is a standard for the broadcast transmission of digital terrestrial television proposed by the DVB European-1 based consortium This system transmits compressed digital audio, video and other data in an MPEG transport stream, using OFDM modulation with concatenated channel coding (i.e. COFDM).

OFDM transmission systems work by splitting the digital data stream into a large number of slower digital streams, each of which digitally modulate a set of closely spaced adjacent carrier frequencies, rather than carrying the data on a single radio frequency carrier,. In the case of DVB-T, there are two choices for the number of carriers known as 2K or 8K. These are actually 1705 or 6817 carriers that are approximately 4 kHz or 1 kHz apart, depending on whether it's a transmission channel of 8, 7, or 6 MHz. DVB-T also offers many other transmission choices of digital modulation (QPSK, 16QAM, 64QAM) and Code rate—forward error correction (FEC). This allows broadcasters to trade off payload data capacity versus improved reliability of reception in different reception conditions.

DVB-T as a digital transmission delivers data in a series of discrete blocks at the clock or symbol rate. DVB-T includes a “Guard Interval” feature where the receiver ignores the data for a short period around the time when the data changes. Within limits, this allows for the receiver to ignore the effects of multipath reception.

However, due to the short time interleaving in present DVB-T systems, present DVB-T systems suffer from short disturbances caused by impulsive noise that may occur with the channel. Thus, in a Digital Video Broadcast-Handheld (DVB-H) system, which is a superset of the DVB-T system, an additional forward error correction layer is employed to improve the error performance. However, a disadvantage of this using the addition FEC layer is that the DVB-H system is no longer backward compatible to the existing DVB-T standard.

Accordingly, there is a need in the industry for a method and system that provides for a very high performance in a DVB-H system with low additional overhead and provides for backward compatibility with existing DVB-T systems.

### SUMMARY OF THE INVENTION

A method and system for providing enhanced encoding and correction capability while retaining backward compatibility with existing DVB-T transport systems is disclosed. The method comprises the steps of encoding a plurality of transport stream bytes into a transport stream matrix, wherein each column of said matrix represents a predetermined number of encoded transport stream bytes and a known number of parity bytes, and encoding said encoded bytes within said columns within corresponding ones of rows of said matrix, wherein a known number of parity bytes are associated with said encoded bytes within said row.

### BRIEF DESCRIPTION OF THE DRAWINGS

The features and advantages of the present invention will be more apparent from the following detailed description in conjunction with the accompanying drawings, in which:

FIG. 1 illustrates a transmission format in accordance with the principles of the invention;

FIG. 2 illustrates a process for implementing the transmission format shown in FIG. 1:

FIG. 3 illustrates a system for implementing the processing shown in FIG. 2.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION OF THE INVENTION

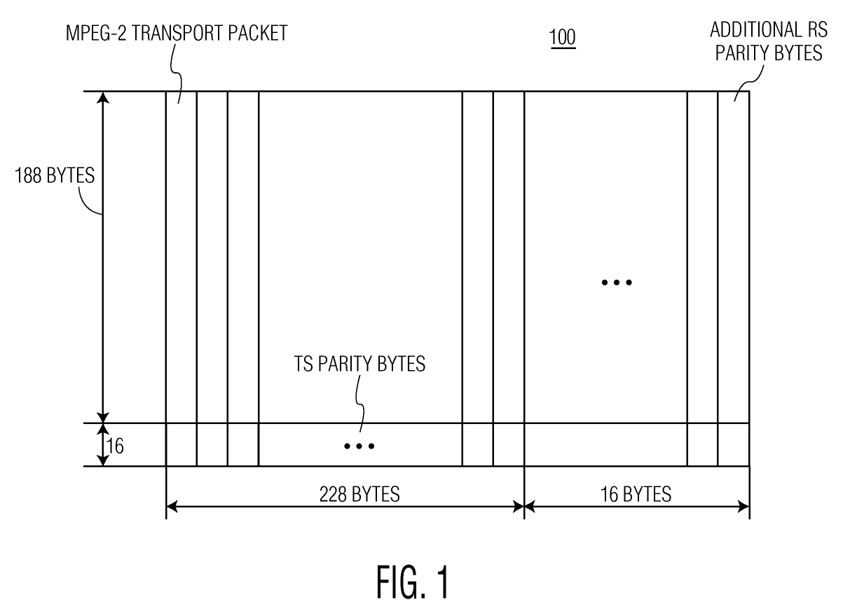

FIG. 1 illustrates an exemplary format of a backward compatible DVB-T transmission packet in accordance with the principles of the invention. Referring to FIG. 1, there is shown an exemplary matrix consisting of 228 MPEG-2 transport stream packets including the sixteen (16) Reed-Solomon parity bytes (columns). Reed-Solomon encoding is well known in the art and need not be discussed in detail herein.

The packets are inserted into the matrix column by column, from the left to the right. Thus every column represents a usual TS packet of 204 bytes (188 bytes and 16 parity bytes). Sixteen additional Reed-Solomon parity bytes are then calculated line by line (228 useful bytes and 16 parity bytes). For this calculation of the additional parity bytes, the same Reed-Solomon encoder may be employed using a different code shortening factor. Or a different Reed-Solomon encoder may be used. Because of the linearity of the applied code, every column and every row inside the matrix represents a valid codeword. Hence, the correction can be done in an iterative way insider the receiver. That is, the correction may be done in the columns (MPEG-2 TS packets), then in the rows and again in the columns and continuing this pattern until correction is completed. Additional enhancements of the error correcting process are possible by taking advantage of channel state information.

In order to remain compliant with the existing DVB-T standard, the additional parity bytes are transmitted with conventional MPEG-2 transport system packets. Thus, a special transport stream PID (Packet Identification) is assigned exclusively to the parity packets. Additionally, a part of the packet carries information on the position of the parity bits inside the matrix.

In order to improve the performance, partly destroyed packets may be used for error correction. Thus, only reliance on the unique PID associated with the additional parity bits is not sufficient as the PID field may be destroyed or not recoverable. Accordingly, a fixed framing structure is further employed wherein additionally parity bits may be inserted in every n^{th} TS packet. For example, additional parity bits may be inserted in every 13^{th} TS packet.

Accordingly, the PID and additional data fields within TS packets are used for synchronization if the packet is received correctly. In order to ensure correctness, an additional CRC (Cyclic Redundancy Code) is calculated over the PID and the position description of the parity bytes inside the matrix.

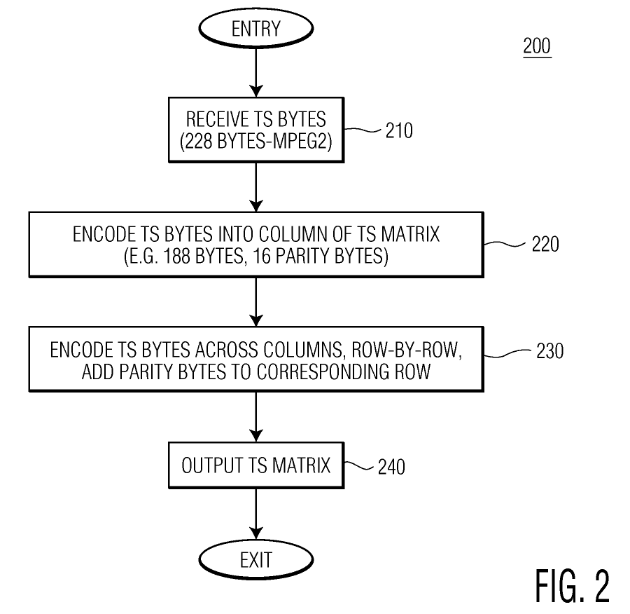

FIG. 2 illustrates a flow chart 200 of a process for inserting additional parity bits in accordance with the principles of the invention. At block 210, 228 Transport Stream packets (TS) are received. At block 220, the 228 TS packets are encoded using, for example, well-known Reed-Solomon (R-S) encoding such that each column of the transport matrix (FIG. 1) represent 188 bytes of the transport stream and 16 R-S parity bytes. The parity bits within a column are associated with the transport bytes within the corresponding column. At block 230 16 additional R-S parity bytes may be calculated line by line (row-by-row). For the calculation of these additional 16 R-S parity bytes may be formulated using the same or different R-S encoder using a different R-S code. Thus, each row and each column in matrix 100 represents a valid codeword such that correction may be performed in an iterative manner within a receiving unit. For example, a correction may be performed on the columns, then on the rows and then again on the columns until no further corrections are necessary.

At block 240 the formulated matrix of encoded TS bytes is output.

In another aspect of the invention, invention a special Packet Identification (PID) code may be assigned exclusively to the parity packets. Additionally, information regarding the position of the parity bytes inside the matrix 100 is allocated to a small part of the matrix 100. In another embodiment, a fixed framing structure may be included wherein every n^{th} (e.g., 13^{th}) transport stream packet may include additional parity bytes. The PID code and additional data field inside the TS packets may be, in this case, used of synchronization. In another aspect, a Cyclic Redundancy Code (CRC) may be calculated over the PID and the position description of the parity bytes within the matrix.

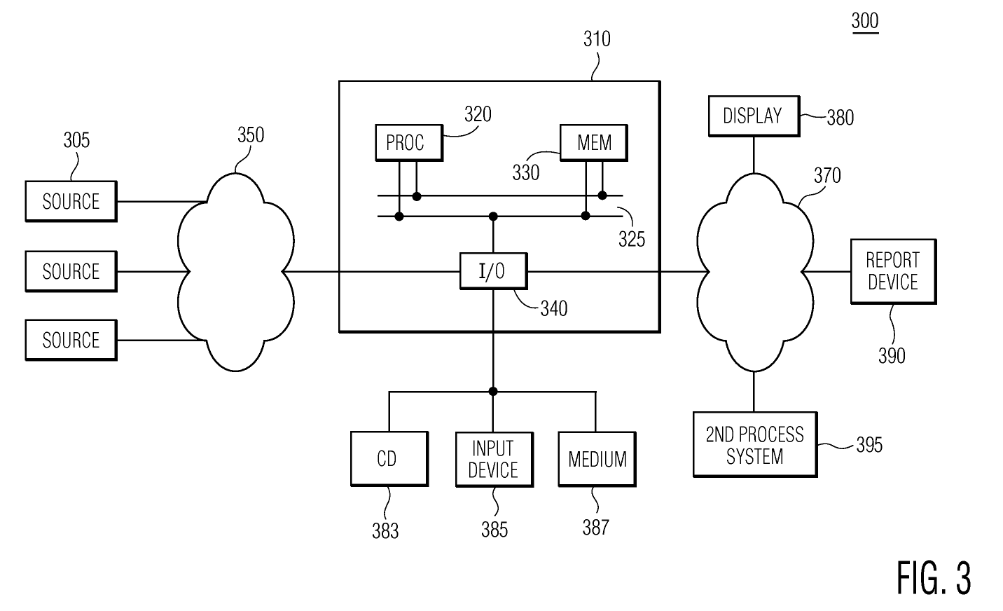

FIG. 3 illustrates a system 300 for implementing the principles of the invention as depicted in the exemplary processing shown in FIG. 2. In this exemplary system embodiment 300, input data is received from sources 305 over network 350 and is processed in accordance with one or more programs, either software or firmware, executed by processing system 310. The results of processing system 310 may then be transmitted over network 370 for viewing on display 380, reporting device 390 and/or a second processing system 395.

Specifically, processing system 310 includes one or more input/output devices 340 that receive data from the illustrated source devices 305 over network 350. The received data is then applied to processor 320, which is in communication with input/output device 340 and memory 330. Input/output devices 340, processor 320 and memory 330 may communicate over a communication medium 325. Communication medium 325 may represent a communication network, e.g., ISA, PCI, PCMCIA bus, one or more internal connections of a circuit, circuit card or other device, as well as portions and combinations of these and other communication media. Processing system 310 and/or processor 320 may be representative of a handheld calculator, special purpose or general purpose processing system, desktop computer, laptop computer, palm computer, or personal digital assistant (PDA) device, etc., as well as portions or combinations of these and other devices that can perform the operations illustrated.

Processor 320 may be a central processing unit (CPU) or dedicated hardware/software, such as a PAL, ASIC, FGPA, operable to execute computer instruction code or a combination of code and logical operations. In one embodiment, processor 320 may include code which, when executed by the processor, performs the operations illustrated herein. The code may be contained in memory 330, may be read or downloaded from a memory medium such as a CD-ROM or floppy disk, represented as 383, may be provided by a manual input device 385, such as a keyboard or a keypad entry, or may be read from a magnetic or optical medium 387 when needed. In this case, the computer readable medium encoded with a computer program is a computer element that defines structural and functional interrelationships between the computer program and the rest of the computer which permit the computer grogram's functionality to be realized.

Information items provided by input device 383, 385 and/or magnetic medium 387 may be accessible to processor 320 through input/output device 340, as shown or through either network 350 and/or 370. Further, the data received by input/output device 340 may be immediately accessible by processor 320 or may be stored in memory 330. Processor 320 may further provide the results of the processing to display 380, recording device 390 or a second processing unit 395.

As one skilled in the art would recognize, the terms processor, processing system, computer or computer system may represent one or more processing units in communication with one or more memory units and other devices, e.g., peripherals, connected electronically to and communicating with the at least one processing unit. Furthermore, the devices illustrated may be electronically connected to the one or more processing units via internal busses, e.g., serial, parallel, ISA bus, microchannel bus, PCI bus, PCMCIA bus, USB, etc., or one or more internal connections of a circuit, circuit card or other device, as well as portions and combinations of these and other communication media, or an external network, e.g., the Internet and Intranet. In other embodiments, hardware circuitry may be used in place of, or in combination with, software instructions to implement the invention. For example, the elements illustrated herein may also be implemented as discrete hardware elements or may be integrated into a single unit. As would be understood, the operations illustrated may be performed sequentially or in parallel using different processors to determine specific values.

Memory 330 comprises means for writing and reading, either sequentially or simultaneously, data in or from different addresses within the memory. Preferably memory 330 comprises a read port and a write port. A read port is understood to mean a port suitable for reading data, which does not exclude that data are also written in this port. Similarly, a write port is understood to mean a port suitable for writing data, which does not exclude that data are also read through this port.

Processing system 310 may also be in two-way communication with each of the sources 305. Processing system 310 may further receive or transmit data over one or more network connections from a server or servers over, e.g., a global computer communications network such as the Internet, Intranet, a wide area network (WAN), a metropolitan area network (MAN), a local area network (LAN), a terrestrial broadcast system, a cable network, a satellite network, a wireless network, or a telephone network (POTS), as well as portions or combinations of these and other types of networks. As will be appreciated, networks 350 and 370 may also be internal networks or one or more internal connections of a circuit, circuit card or other device, as well as portions and combinations of these and other communication media or an external network, e.g., the Internet and Intranet.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. For example, although the invention has been described with regard to a matrix of 228 columns, it would be within the knowledge of those skilled in the art to alter the number of columns and, thus, such alterations is considered within the scope of invention claimed.

It is expressly intended that all combinations of those elements that perform substantially the same function in substantially the same way to achieve the same results are within the scope of the invention. Substitutions of elements from one described embodiment to another are also fully intended and contemplated.

What is claimed:

1. A method for formulating a transport stream packet comprising:
encoding a plurality of transport stream bytes into a transport stream matrix, wherein each column of said matrix represents a predetermined number of encoded transport stream bytes and a known number of parity bytes; and
encoding said encoded bytes within said columns within corresponding ones of rows of said matrix, wherein a known number of parity bytes are associated with said encoded bytes within said row.

2. The method as recited in claim 1, further comprising:
assigning a PID to said encoded transport stream matrix.

3. The method as recited in claim 2, further comprising:
assigning a parity position indication within said encoded transport stream matrix.

4. The method as recited in claim 3, further comprising:
determining a CRC of said encoded transport stream matrix; and
storing said CRC within said transport stream matrix.

5. The method as recited in claim 1, wherein said encoding is performed using a Reed-Solomon code.

6. The method as recited in claim 5, wherein said first and second encoding steps utilize different code shorting factor.

7. The method as recited in claim 1, wherein each of said columns includes 188 TS bytes and 16 parity bytes.

8. The method as recited in claim 1, wherein said known number of parity bytes within said row is 16.

9. The method as recited in claim 1, further comprising:
outputting said encoded transport stream matrix.

10. The method as recited in claim 1, wherein said transport stream packet includes 228 bytes.

11. An apparatus for formulating a transport stream packet comprising:
a processor in communication with a memory, the memory including code which when accessed by the processor causes the processor to:
receive a plurality of transport stream byes;
encode said plurality of transport stream bytes into a transport stream matrix, wherein each column of said matrix represents a predetermined number of encoded transport stream bytes and a known number of parity bytes; and
encode said encoded bytes within said columns within corresponding ones of rows of said matrix, wherein a known number of parity bytes are associated with said encoded bytes within said row.

12. The apparatus as recited in claim 11, the processor further:
assigning a PID to said encoded transport stream matrix.

13. The apparatus as recited in claim 12, the processor further:
assigning a parity position indication within said encoded transport stream matrix.

14. The apparatus as recited in claim 13, the processor further:
determining a CRC of said encoded transport stream matrix; and
storing said CRC within said transport stream matrix.

15. The apparatus as recited in claim 11, wherein said encoding is performed using a Reed-Solomon code.

16. The apparatus as recited in claim 15, wherein said first and second encoding steps utilize different code shorting factors.

17. The apparatus as recited in claim 11, wherein each of said columns includes 188 TS bytes and 16 parity bytes.

18. The apparatus as recited in claim 11, wherein said known number of parity bytes within said row is 16.
